(19) United States
(12) Patent Application Publication
(10) Pub. No.: US 2023/0256892 A1
(43) Pub. Date: Aug. 17, 2023

(54) TARPING SYSTEM FOR CARGO LOAD

(71) Applicant: SPEED TARP, LLC, SAINT CHARLES, MI (US)

(72) Inventor: DAVID J. MAYER, SAINT CHARLES, MI (US)

(21) Appl. No.: 18/004,739

(22) PCT Filed: Jul. 9, 2021
(86) PCT No.: PCT/US2021/041053

§ 371 Date: Jan. 9, 2023

Related U.S. Application Data
(60) Provisional application No. 63/050,726, filed on Jul. 10, 2020.

(51) Int. Cl. B60P 7/04; B60J 7/08

(52) U.S. Cl. CPC B60P 7/04; B60J 7/085

(57) ABSTRACT

A tarping system and method for covering at least a portion of a cargo load carried on a cargo carrying surface of a bed of a truck or trailer are provided. The tarping system includes at least one flexible tarp extending from a mounted end to a free end. At least one reel is coupled to the mounted end and is operative to automatically urge the tarp to a self-stowed positon, coiled onto a spool of the reel, under a return force imparted by the reel. A mounting structure is configured to support the at least one reel and the associated tarp in an upstanding relation relative to the cargo carrying surface to enable a user, while standing on the ground, to draw the tarp from the stowed position to a deployed position to cover at least a portion of a side of the cargo load.

### CROSS-REFERENCE TO RELATED APPLICATION

This U.S. National Phase application claims the benefit of International Application No. PCT/US2021/041053, filed Jul. 9, 2021 and U.S. Provisional Application Serial No. 63/050,726, filed Jul. 10, 2020, both of which are incorporated herein by reference in their entirety.

### BACKGROUND OF THE INVENTION

### 1. Technical Field

This invention relates generally to tarping systems used for covering material loads transported on the bed of a commercial truck or trailer to protect the tarped load from exposure to inclement weather conditions, such as rain.

### 2. Related Art

It is common in the commercial trucking industry to utilize a tarp to cover material loads that are transported on the bed of a truck or trailer to protect the load from exposure to rain and other inclement weather and road conditions that may be encountered in transport.

Traditional tarps are typically large and heavy and require at least one and often two or more persons to drape the tarps over the load and then secure the draped sides of the tarp to anchor points of the bed, such as by straps or elastic cords. This is not only time consuming and labor intensive, it often requires at least one person to be present on top of the load to assist in the positioning and manipulation of the tarp during installation and in some cases removal of the tarp.

Sometimes weather conditions are such that full tarping is not needed, such as when there has been a recent rainstorm and the threat of further rain is passed, yet the road surfaces may still be wet or there may be patches of wet road conditions that are likely to be encountered along a route. In such cases, the trouble of having to tarp the full load may outweigh the likelihood of getting the bottom 3-4 feet of the sides of the load wet from spray coming off the tires of the truck and/or trailer. Some loads, such as drywall or other types of materials sensitive to water and moisture, are best kept dry at all times, even under tire spray conditions. The current solution is to go with full tarping under any inclement road conditions, even when only the lower 4 feet or so of the load may be at risk of exposure.

### SUMMARY OF THE INVENTION

A tarping system according to one aspect of the invention includes one or more tarps that extend from a cargo carrying surface of a truck bed or trailer upward to provide protective side curtains to a cargo load being carried on the cargo carrying surface, wherein the one or more tarps are self-coiled under a return force, while in a stowed position, on a respective reel supported by the truck bed or trailer.

According to a further aspect, a mounted end of the tarp is coupled to the reel and a free end of the tarp can be drawn away from the reel against the return force for releasable fixation proximate a back end of the truck bed or trailer when moved to a deployed position.

According to a further aspect, the reel can have a bias assist mechanism, such as a spring, motor or the like, which operates to assist in the rolling of the tarp on the reel when not in use, thereby rendering the tarp self-coiling, and may further provide a constant tension on the tarp to help keep the tarp taught when moved to the deployed position with the free end releasably coupled to a catch member proximate the back end of the truck bed or trailer.

According to a further aspect, the reel may be spring-loaded to automatically bias the tarp toward the self-coiled (rolled), stowed position, wherein a user may grab the free end of the tarp and draw the tarp off the reel under an applied tension load sufficient to overcome the spring load and then releasably secure the free end proximate a back portion of the truck bed or trailer, whereby the spring-loaded bias imparted by the reel tensions the tarp taught against the side of the cargo load to provide a streamline contour of the tarp that resists fluttering of the tarp in use, thereby minimizing noise and enhancing fuel economy.

According to a further aspect, the tarps may be deployed and stowed by a single operator, also referred to as user, while standing on the ground, wherein there is no need for an operator to be on the truck bed or trailer or standing on the load while applying or removing the tarps.

According to a further aspect, a top surface of the cargo load can remain untarped (uncovered).

According to a further aspect, a top surface of the cargo load can be tarped (covered) by a tarp dispensed from an overhead top reel extending generally transversely to a pair of reels configured in upstanding relation proximate opposite sides of the cargo carrying surface.

According to a further aspect, the one or more reels and tarps may be mounted for selective removable from the truck or trailer.

According to a further aspect, the free end of the tarp may include a grab handle for grasping by the operator while moving the tarp between the stowed and deployed positions.

According to a further aspect, the grab handle may also serve as part of a latching mechanism, with another part of the latching mechanism being provided at the back end of the truck bed or trailer for releasably securing the tarp in the deployed condition when in use.

In accordance with these and other aspects, a tarping system for covering at least a portion of a cargo load carried on a cargo carrying surface of a bed of a truck or trailer includes at least one flexible tarp extending along a lengthwise direction from a mounted end to a free end. At least one reel is coupled to the mounted end of the tarp. The reel is operative to urge the tarp toward a stowed positon, coiled onto a spool of the reel, under a return force imparted by the reel, while enabling a user to draw the tarp outwardly from the reel in the lengthwise direction against the return force from the stowed position to a deployed position. At least one mounting structure is configured to support the at least one reel and the at least one tarp in an upstanding relation relative to the cargo carrying surface to enable the user to draw the tarp from the stowed position to the deployed position to cover at least a portion of a side of the cargo load.

In accordance with a further aspect, the at least one flexible tarp can include first and second flexible tarps, the at least one reel can include first and second reels, and the at least one mounting structure can include first and second mounting structures. Each of the first and second mounting structures are configured to support separate ones of the first and second reels and separate ones of the first and second tarps, disposed in self-coiled fashion on respective ones of the first and second reels, in the upstanding relation on opposite sides of the cargo carrying surface to cover at least a portion of opposite sides of the cargo load.

In accordance with a further aspect, the at least one flexible tarp can further include a third flexible tarp, the at least one reel can further include a third reel, and the at least one mounting structure can further include a third mounting structure. The third mounting structure is configured to support the third reel and the third flexible tarp, disposed in self-coiled fashion on the third reel, in generally transverse relation to the first and second reels and the first and second tarps for covering at least a portion of a top of the cargo load.

In accordance with a further aspect, one or more of the first, second, and third tarps can be moved to its deployed position, while one or more of the first, second, and third tarps can remain in its stowed position, thereby allowing the user flexibility as to when each of the tarps is deployed and stowed, for any reason.

In accordance with a further aspect, with the first, second and third tarps being independent and separate from one another, any one or more of the tarps can be replaced with a new tarp, separately from the other tarps, when desired, thereby minimizing the cost associated with maintaining the tarps in full operable condition.

In accordance with a further aspect, the first and second flexible tarps can each include a grab handle coupled to the free end, with the grab handles being configured to be grasped by the user, while standing on a ground surface, for tensioning the first and second tarps while drawing the first and second tarps from the stowed position to the deployed position against the return force and while returning the tarps from the deployed position to the stowed position under the self-imparted return force.

In accordance with a further aspect, catch members can be operably fixed to the cargo carrying surface in spaced relation along the lengthwise direction from the first and second reels for releasably engaging the grab handles to releasably hold the first and second tarps in the deployed position against the return force imparted by the first and second reels.

In accordance with a further aspect, each of the first and second mounting structures can include a first and second top bracket operably fixed relative to the cargo carrying surface for slideably receiving a top end of the first and second reels and a first and second bottom bracket operably fixed relative to the cargo carrying surface for supporting a bottom end of the first and second reels, such that the first and second mounting structures provide a quick and easy, and thereby economical mechanism for assembly and disassembly of the first and second reels with the truck bed or trailer by a single user.

In accordance with a further aspect, to facilitate quick, easy, and economical assembly and disassembly of the first and second reels, the first and second top brackets are dimensioned to enable the top end of the first and second reels to be extended sufficiently into a top receptacle of the respective first and second top brackets, whereupon the first and second reels can be easily lowered to slide and seat the bottom ends into a bottom receptacle of the respective first and second bottom brackets, and to enable the reverse to occur to dismount (disassemble) the first and second reels from the first and second mounting structures.

In accordance with a further aspect, the mounted end of the at least one tarp can include at least one of openings for releasably coupling the at least one tarp to the at least one reel, or a portion of a hook and loop fastener for releasably coupling the tarp to the at least one reel.

In accordance with a further aspect, the return force imparted by the reel can be provided as a constant spring biased return force, with the spring being provided as any desired spring type, such as a torsion spring member.

In accordance with a further aspect, the flexible tarps can be provided being lightweight and durable, such as from a textile material.

In accordance with a further aspect, the textile material of the flexible tarps can be provided being woven.

In accordance with a further aspect, the woven material of the flexible tarps can be provided including multifilaments, such as having a denier between about 300-700, and more preferably between about 400-600, with one exemplary embodiment containing multifilaments of nylon having a denier of about 420.

In accordance with a further aspect, the woven material of the flexible tarps can be provided being woven entirely with multifilaments, thereby enhancing the flexibility and protection coverage against the passage of contamination (fluid and solid debris) therethrough.

In accordance with a further aspect, the tarping system can be made purely mechanical, without need for electrically powered motors or other electrically powered mechanisms, thereby rendering the tarping system free for use without need of an electrical source of power, and further rendering the tarping system economical in manufacture and in use.

According to an aspect, a method for tarping a cargo load carried on a cargo carrying surface of a bed of a truck or trailer includes orienting one or more upstanding tarps in a generally vertical orientation to either or both sides of the cargo load with forward (toward a front facing end of the bed or trailer) and rearward (toward a rear facing end of the bed or trailer) ends of the one or more upstanding tarps anchored and with just the lower approximately 4 feet of the cargo load covered from exposure from road spray under wet road conditions and the portion of the cargo load above the one or more upstanding tarps being uncovered by the upstanding tarps.

According to a further aspect, the method can include orienting an overhead tarp in a generally horizontal relation relative the one or more upstanding tarps and extending the overhead tarp, separately from the upstanding tarps, to cover at least a portion of an upper surface of the cargo load.

According to a further aspect, the method includes mounting the upstanding tarps on separate reels mounted adjacent one end of the bed or trailer, with the reels being mechanically biased to urge the upstanding tarps toward being wound (also referred to as spooled or coiled) about the reels, wherein an operator on the ground may grasp a free end of one or both of the upstanding tarps and draw (pull) the upstanding tarps off the reels against the bias force imparted by the reels and secure the free ends to the truck bed or trailer adjacent the opposite end of the truck bed or trailer from which the reels are mounted to cover and shield the sides of the cargo load against exposure to water, such as splashed from a road surface, all while standing on the ground.

According to a further aspect, the reels at one end and the latching mechanism at the opposite end are preferably inset from the side edges of the bed.

According to a further aspect, the reels are mounted at a forward end of the bed adjacent a front support of a boom lift apparatus mounted to the bed and the latching mechanism is mounted at the rearward end of the bed adjacent a rear support of the boom lift apparatus.

According to another aspect, the tarping system is purely mechanical and the tarps able to be deployed and stowed by a single operator without having to leave the ground (operator does not need to climb on the truck bed, trailer or cargo load).

According to a further aspect, a lower, lengthwise extending edge region of the upstanding tarps may be provided with a plurality of spaced grommets to provide anchor points to receive a tie-down devices, such as elastic bungee cords for releasable securing the lower edge of the tarp to the truck or trailer at or adjacent the bed along its length to impede spray from entering beneath the tarp when deployed in use.

According to a further aspect, a further method of tarping a cargo load carried on a cargo carrying surface of a bed of a truck or trailer includes: providing at least one reel mounted in an upstanding relation relative to the cargo carrying surface with each of the reels being operative to self-coil a tarp under a mechanical bias force onto a spool portion of the reel to a stowed position. Further, a user, while standing on a ground surface, drawing the tarp off one or more of the spool portion of the at least one reel against the mechanical bias force to an extended, deployed position to cover at least a portion of a side of the cargo load and releasably fixing the tarp in the extended, deployed position.

According to another aspect, the method can further include providing the at least one reel including two reels supported in the upstanding relation on opposite sides of the cargo carrying surface, and wherein the user covers at least a portion of the opposite sides of the cargo load by individually drawing the tarps off the reels against the mechanical bias force and securing grab handles coupled to the tarps with respective catch members fixed relative to the truck bed or trailer.

According to another aspect, the method can further providing the at least one reel including an overhead top reel with a top tarp self-coiled thereon under a mechanical bias force, wherein the user extends the top tarp against the mechanical bias force to cover at least a portion of a top surface of the cargo load.

### BRIEF DESCRIPTION OF THE DRAWINGS

These and other features and advantages of the invention may be readily appreciated as the same becomes better understood when considered in connection with the following detailed description and drawings, in which:

FIG. 1 is a side view of an exemplary motor vehicle configured for transporting a cargo load on a cargo carrying surface, such as on a bed of the motor vehicle or a trailer bed towed by the motor vehicle, with the cargo carrying surface being equipped with a tarping system in accordance with the disclosure;

FIG. 2 is a fragmentary perspective view of the tarping system of FIG. 1 showing a pair of upstanding side reels configured to facilitate protecting opposite side surfaces of the cargo load with flexible, lightweight and durable tarps dispensed therefrom and an overhead top reel configured to facilitate protecting a top surface of the cargo load with a flexible, lightweight and durable tarp dispensed therefrom against exposure to contamination, such as water and debris off a road surface;

FIG. 3 is a fragmentary perspective view showing the tarps extended from the upstanding side reels to cover opposite sides of the cargo load;

FIGS. 4A-4C illustrate alternate embodiments for coupling the tarp to a spool of the respective upstanding side reels and overhead top reel;

FIG. 5 is a fragmentary top plan view showing a mounting arrangement of the overhead top reel to a member operably fixed to the cargo carrying surface in accordance with an aspect of the disclosure;

FIG. 6 is a fragmentary side view of one of the tarps of the upstanding side reels illustrating a grab handle coupled to the free end of the tarp to facilitate moving the tarp from a non-deployed, retracted position, coiled within the upstanding side reel, to a deployed, extended position, uncoiled outwardly from the upstanding side reel;

FIG. 7 is perspective view illustrating the tarps of the upstanding side reels and the tarp of the overhead top reel moved to their respective deployed, extended positions to protect the side surfaces and top surface of the cargo against exposure to contamination;

FIG. 8 is a top plan view of the tarps of the upstanding side reels moved to and releasably retained in their respective deployed, extended positions by the grab handles being coupled to catch members operably fixed to the cargo carrying surface, with the cargo shown having a non-symmetrical contour along the opposite side surfaces and with the tarps shown substantially conforming to the non-symmetrical contour to provide streamline protection against exposure to contamination to the opposite side surfaces the cargo;

FIG. 9 is a fragmentary top plan view of a crane pedestal region of the motor vehicle illustrating catch members used to releasably secure tarps uncoiled from the upstanding side reels in their deployed positions;

FIG. 10 is a view similar to FIG. 1 illustrating an operator using a standard fork lift to move a top tarp to an extended, deployed position; and

FIG. 11 is a flow diagram illustrating a method of tarping a cargo load carried on a cargo carrying surface of a bed of a truck or trailer in accordance with another aspect of the invention.

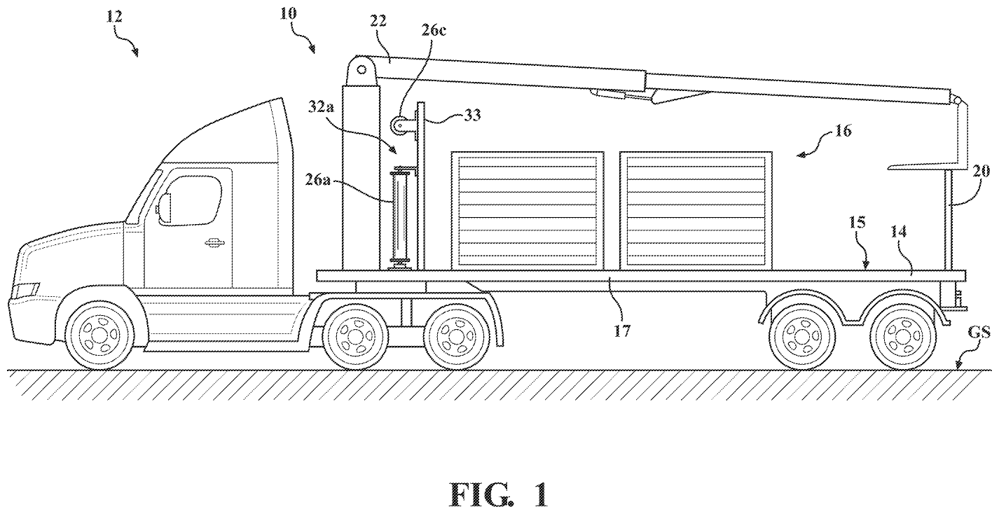

### DETAILED DESCRIPTION OF EMBODIMENTS OF THE INVENTION

An embodiment of a tarping system 10 embodying various aspects of the invention for use on motor vehicles, such as trucks and trailers of the type made for carrying a cargo load, such as building materials, including drywall and the like, is illustrated in the Figures.

The truck or trailer is generally indicated at 12 having a bed 14 that is elevated off a ground surface GS and providing a cargo carrying surface 15 for supporting the cargo load, such as stacks of drywall 16, by way of example and without limitation. The cargo load 16 typically rests on the bed 14, either directly or on pallets, and rises at least four feet off the bed 14 and typically higher (e.g., 8 feet). The cargo load 16 is typically secured by straps that cross over the cargo load 16 and are secured to anchor points of the truck 12 along opposite sides 17, 19 of the bed 14 in the usual manner.

The truck 12 may be equipped with a boom crane 18, known to the art, mounted on the bed 14 of the truck 12 and including front and rear boom crane support structures used for offloading the material (e.g., stacks of drywall) at a delivery location/job site. In the illustrated embodiment, adjacent the rear end of the track bed 14 has a crane pedestal 20 on which the crane is mounted, and a boom rack 22 is provided toward the front of the bed 14. Both structures 20, 22 are inset from the sides 17, 19 of the bed 14.

The tarping system 10 includes at least one and preferably two flexible tarps, referred to hereafter as first and second tarps 24a, 24b, and can further yet include another flexible tarp, referred to hereafter as third tarp 24c. The first, second and third tarps 24a, 24b, 24c each have a length and width. The length is oriented to extend along a lengthwise direction of the truck bed 14, which coincides with a lengthwise direction of the motor vehicle 12. The length of the tarps 24a, 24b, 24c is preferably least 4-6 times or more than a width of the tarps 24a, 24b, 24c. In the embodiment illustrated, the width represents the height of the first and second tarps 24a, 24b as they are supported in an upstanding, vertical or near vertical, also referred to as substantially vertical position (perpendicular or substantially perpendicular to the cargo carrying surface 15 of the bed 14 of the truck/trailer 12). For the third tarp 24c, the width extends generally transversely between the opposite sides 17, 19 of the bed 14, such that the third tarp 24c extends along a plane that is perpendicular or substantially perpendicular to the planes along which the first and second tarps 24a, 24b extend. The width/height is preferably about 4 feet, but could be shorter or longer to achieve the desired side coverage of the material under a given condition. The length of the tarps 24a, 24b, 24c corresponds to approximately the length of the bed 14. For example, the tarps 24a, 24b, 24c may have a length between about 10-30 feet, but could be longer or shorter depending upon the given application.

The tarping system 10 includes front and rear supports for the first, second and third tarps 24a, 24b, 24c, such that the first and second tarps 24a, 24b can be supported vertically to the outside of the cargo load 16 and provide coverage along the length of the cargo load 16 and vertically over the height/width of the first and second tarps 24a, 24b (e.g., about 4 feet of vertical coverage above the surface of the bed 14). The tarping system 10 includes a corresponding number of first, second and third reels 26a, 26b, 26c to the numbers of tarps, with the reels 26a, 26b, 26c having central spool portions, also referred to as spools, proximate (at, near or immediately adjacent) one end of the bed 14 and associated latches, also referred to as catch members 28 proximate the opposite end of the bed 14. It is preferred that the reels 26a, 26b, 26c be mounted proximate the front end of the bed 14, and the catch member 28 be mounted proximate the rear end of the bed 14.

First and second reels 26a, 26b are mounted in upstanding relation (vertically) and preferably to or immediately adjacent the front boom rack 22 via respective first and second mounting structures 32a, 32b, such that the first and second reels 26a, 26b are spaced inwardly from the sides 17, 19 of the bed 14. First and second mounting structures 32a, 32b are shown fixed to an upstanding bulkhead 33 and facing forward from the bulkhead 33 toward a front of the truck 12. The first and second tarps 24a, 24b are spooled, also referred to as coiled or rolled onto the corresponding first and second reels 26a, 26b when in a stowed position. A winding mechanism, also referred to as biasing member, such as a torsion spring, is provided on each reel 26a, 26b to constantly bias the first and second tarps 24a, 24b under a return force toward the rolled/stowed condition. Absent an externally applied force sufficient to over the return force imparted by the winding mechanism, the first and second tarps 24a, 24b are automatically self-coiled to their stowed position. The first and second tarps 24a, 24b have a leading free end 29a, 29b which is accessible when the first and second tarps 24a, 24b are rolled to their stowed position. The free end 29a, 29b is preferably equipped with a handle 30 that may be in the form of a bent rod, by way of example and without limitation, having one leg 30a thereof slid into a vertical pocket or sleeve at the free end 29a, 29b of the tarp 24a, 24b and another leg 30b spaced forward of the free end 29a, 29b for grasping by a user.

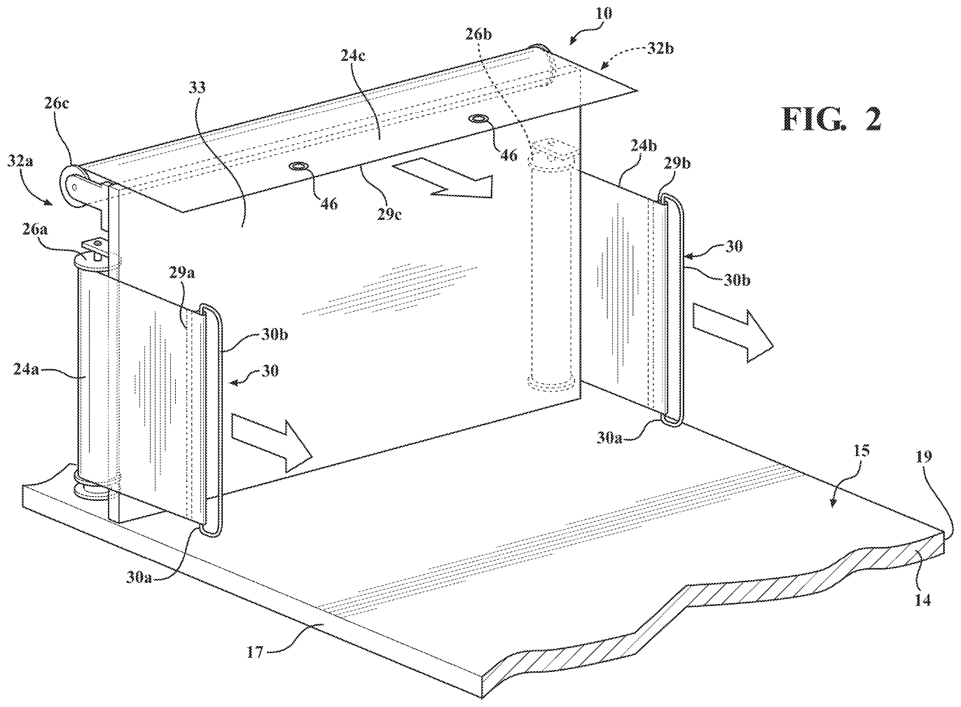

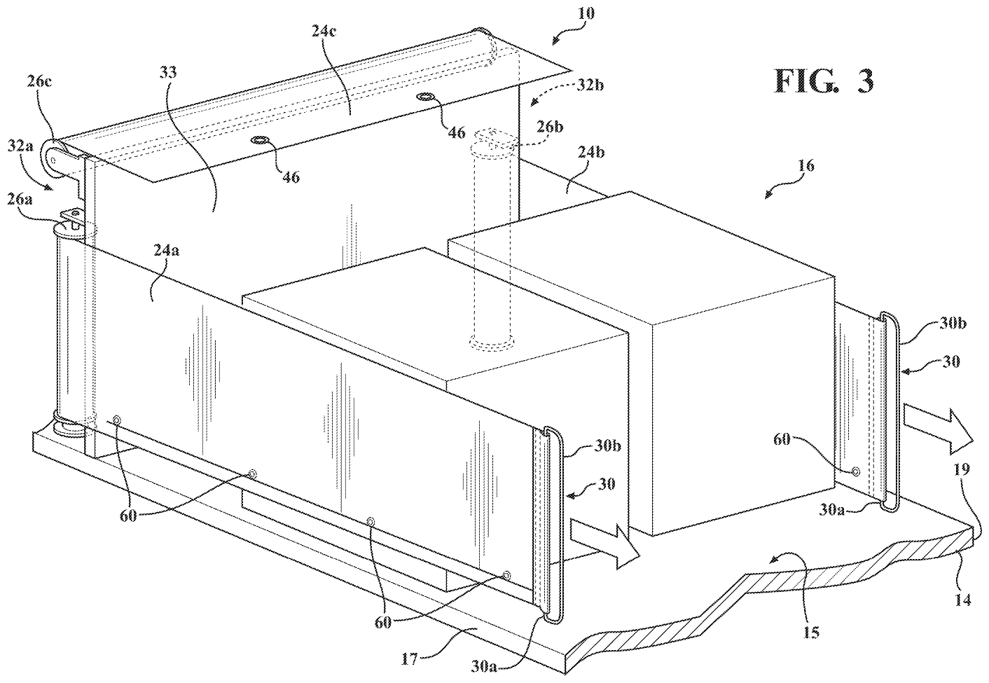

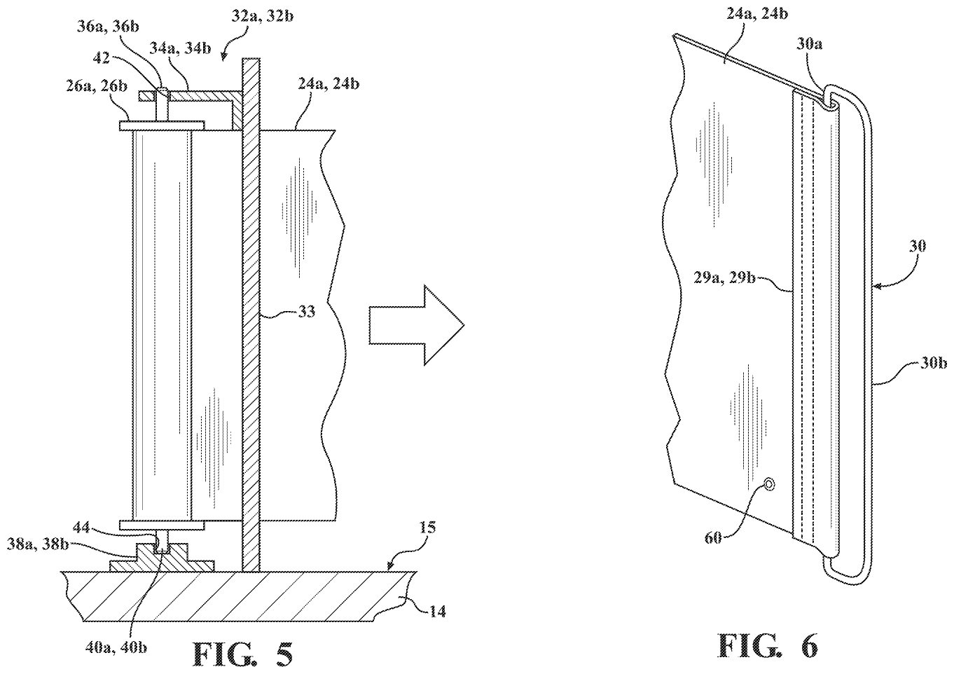

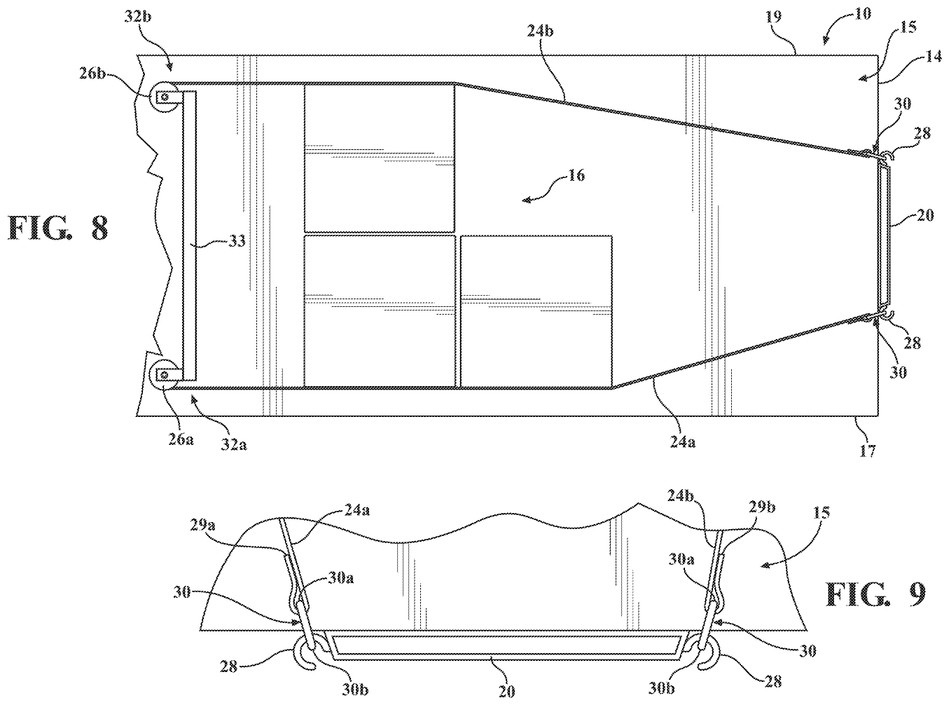

The first and second mounting structures 32a, 32b are configured to support the first and second reels 26a, 26b, respectively, and the corresponding first and second tarps 24a, 24b in their upstanding relation relative to the cargo carrying surface 15 to enable the user to draw the first and second tarps 24a, 24b from the stowed position to the deployed position to cover at least a portion of a side of the cargo load 16, and preferably the entirety of the side of the cargo load 16, and at least a lowermost portion, and preferably between 4-6 ft upwardly from the cargo carrying surface 16 across the entire lengthwise extending direction of the cargo load 16. The first and second tarps 24a, 24b are rolled onto the respective reels 26a, 26b so that the tarps 24a, 24b unwind outwardly from the reels 26a, 26b, as opposed to inwardly, thereby being optimally positioned to extend about an outer side surface of the cargo load 16, as best shown in FIGS. 2, 3, 7 and 8. As best shown in FIG. 5, the first and second mounting structures 32a, 32b include corresponding first and second top brackets 34a, 34b operably fixed relative to the cargo carrying surface 15 for slideably receiving a top end 36a, 36b of the first and second reels 26a, 26b and corresponding first and second bottom brackets 38a, 38b operably fixed relative to the cargo carrying surface 15 for supporting a bottom end 40a, 40b of the respective first and second reels 26a, 26b. Each of the first and second top brackets 34a, 34b is dimensioned to enable the top end 36a, 36b of the first and second reels 26a, 26b to be extended sufficiently into a top receptacle, such as a through opening 42, of the respective first and second top brackets 34a, 34b, whereupon the first and second reels 26a, 26b can be lowered to slide and seat the bottom ends 40a, 40b into a bottom receptacle, such as a recess pocket 44, of the respective first and second bottom brackets 38a, 38b for purposes of mounting the first and second reels 26a, 26b, and to enable the reverse sequence to occur to quickly and easily dismount the first and second reels 26a, 26b from the first and second mounting structures 32a, 32b.

The catch members 28 at the rear end of the bed 14 function to secure the first and second tarps 24a, 24b in an extended use position along opposite sides of the cargo load 16 and against the bias return force of the first and second reels 26a, 26b. The catch members 28 are preferably inset from the sides 17, 19 of the bed 14 and more preferably, in one exemplary embodiment, are mounted to the sides of boom pedestal 20. Both the first and second reels 26a, 26b and catch members 28 may set inward of the sides of the cargo load 16 as well. The catch members 28 are designed to releasably secure the free end 29 of the first and second tarps 24a, 24b. More particularly, the catch members 28 are designed to releasably couple with the legs 30b of the handles 30 to releasably lock the first and second tarps 24a, 24b in the fully extended, use position. The catch members 28 may be in the form of vertically extending C-shaped channels, referred to as C-channels, having a length slightly shorter than the length of the leg 30b, or as hooks, as shown. The open side of the hooks 28 preferably face the rear (away from the first and second reels 26a, 26b) and are secured such as by welding, by way of example and without limitation, to the sides of the pedestal 20, and more preferably with the bottom hook 28 spaced a few inches off the bed 14 of the truck to accommodate a lower horizontal leg 30a of the handle 30, and with an upper horizontal leg 30a extending over a top hook 28, with the vertically extending leg 30b being free for grasping in use. The hooks 28 be spaced vertically from one another, as desired, such that the vertically extending leg 30b of handle 30 can be releasably fixed over the pair of spaced apart hooks 28.

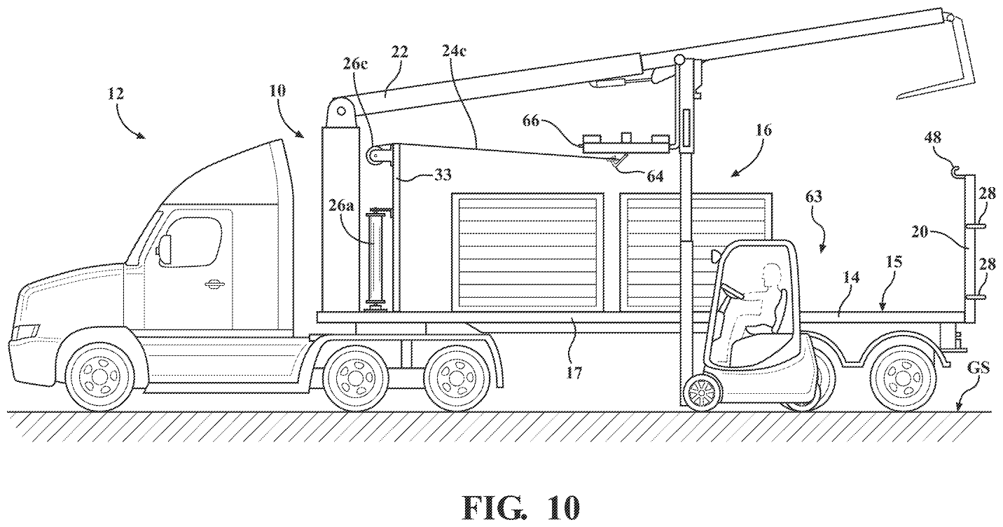

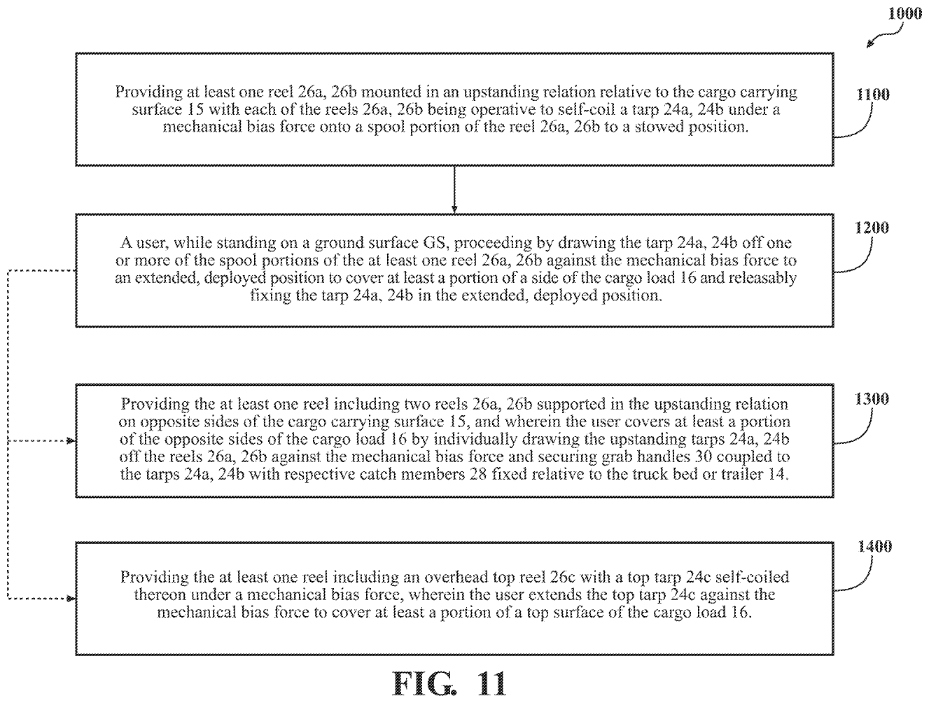

The third tarp 24c is spooled, also referred to as coiled or rolled onto the corresponding third reel 26c when in a stowed position, as discussed above for first and second tarps 24a, 24b. As such, a winding mechanism, such as a torsion spring, is provided on the overhead top reel, referred to as third reel 26c, to constantly bias the third tarp 24c under a return force toward the rolled/stowed condition. Thus, the third tarp 24c and third reel 26c are similar to that discussed above for first and second tarps 24a, 24b and first and second reels 26a, 26b. However, the orientation of the third tarp 24c and the third reel 26c are transverse to the first and second tarps 24a, 24b and the first and second reels 26a, 26b. Accordingly, a third mounting structure 32c is configured to support the third reel 26c and the third tarp 24c in generally transverse relation to the first and second reels 26a, 26b and the first and second tarps 24a, 24b for covering at least a portion, and preferably the entirety of a top of the cargo load 16. In one embodiment, the third reel 26c is positioned above the first and second reels 26a, 26b. To facilitate releasably fixing the third tarp 24c in its extended use position, as shown in FIG. 10, a plurality of eyelets or grommets 46 can be provided adjacent the free end 29c of the third tarp 24c, with the grommets 46 being located for releasably attachment to corresponding hook members 48, such as can be attached to crane pedestal 20. The third reel 26c, as with the first and second reels 26a, 26b, is shown fixed to the bulkhead 33 so that it faces forward toward the front of the truck 12, with the third tarp 24c shown as being coiled to unwrap upwardly from the third reel 26c so as to be best positioned to cover the upper surface of the cargo load 16.

With the first, second and third reels 26a, 26b, 26c being independent from one another, it is to be appreciated that the corresponding first, second and third tarps 24a, 24b, 24c can be serviced separately and independently from one another. As such, any one of the first, second and third reels 26a, 26b, 26c and/or first, second and third tarps 24a, 24b, 24c can be service when needed without having to service other of the first, second and third reels 26a, 26b, 26c and/or first, second and third tarps 24a, 24b, 24c that are not in need of servicing. Accordingly, the tarping system 10 is economical in use and in service, such as may be need to repair a damage reel and/or tarp.

The tarps 24a, 24b, 24c are formed to be highly flexible, lightweight, while also being durable and economical. In accordance with one preferred aspect, the first, second and third tarps 24a, 24b, 24c can be formed from a woven material having a tightly woven pattern, such as a plain weave or basket weave, by way of example and without limitation, with suitably flexible and durable yarns. The woven material of the flexible tarps can be provided including multifilaments, such as having a denier between about 300-700, and more preferably between about 400-600, with one exemplary embodiment containing multifilaments of nylon having a denier of about 420. The woven material of the flexible tarps 24a, 24b, 24c can be provided being woven entirely with multifilaments, thereby enhancing the flexibility and protection coverage against the passage of contamination (fluid and solid debris) therethrough. It is to be understood that monofilaments can be included in a warp and/or weft direction with the multifilaments to enhance abrasion resistance, if desired. It is to be further understood that the tarps 24a, 24b, 24c can be made of a flexible, impervious sheet/film, or the above woven fabric can be laminated/coated with an impervious sheet/film, if desired.

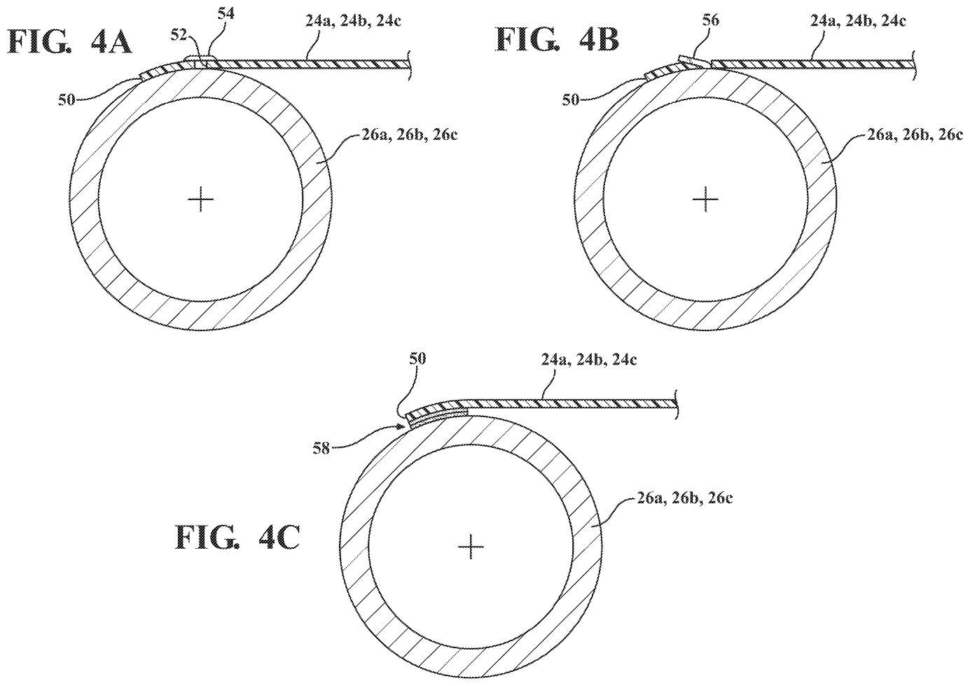

As shown in FIGS. 4A-4C, the first, second and third tarps 24a, 24b, 24c have a coupling end 50 opposite the free end 29, with the coupling end 50 being configured for fixed attachment to the spool region of the respective first, second and third reels 26a, 26b, 26c. In accordance with one aspect, as shown in FIG. 4A, the first, second and third tarps 24a, 24b, 24c can be provided with fastener openings 52, such as narrow slits, configured for fixed receipt of a fastener member 54 fixed to the first, second and third reels 26a, 26b, 26c, such as a rivet or button-type fastener therein, much like a shirt button. In accordance with another aspect, as shown in FIG. 4B, first, second and third tarps 24a, 24b, 24c can be fixed to the respective first, second and third reels 26a, 26b, 26c via tangs 56 projecting from the first, second and third reels 26a, 26b, 26c, with the tangs 56 piercing and/or being bent into fixed attachment with the material of the first, second and third tarps 24a, 24b, 24c. In accordance with yet another aspect, as shown in FIG. 4C, first, second and third tarps 24a, 24b, 24c can be fixed to the respective first, second and third reels 26a, 26b, 26c via a hook-and-loop (Velcro®) type fastener 50, with a hook portion of the fastener 58 being fixed to one of the first, second and third tarps 24a, 24b, 24c and the first, second and third reels 26a, 26b, 26c and a loop portion of the fastener 58 being fixed to the other of the first, second and third tarps 24a, 24b, 24c and the first, second and third reels 26a, 26b, 26c, with the hook and loop portions be aligned for fixed attachment with one another. As such, if need be, during service of any one or more of the first, second and third tarps 24a, 24b, 24c and/or first, second and third reels 26a, 26b, 26c, the respective tarp(s) 24a, 24b, 24c can be easily and intuitively disassembled from the associated reel(s) 26a, 26b, 26c to service the component needing repair/replacement.

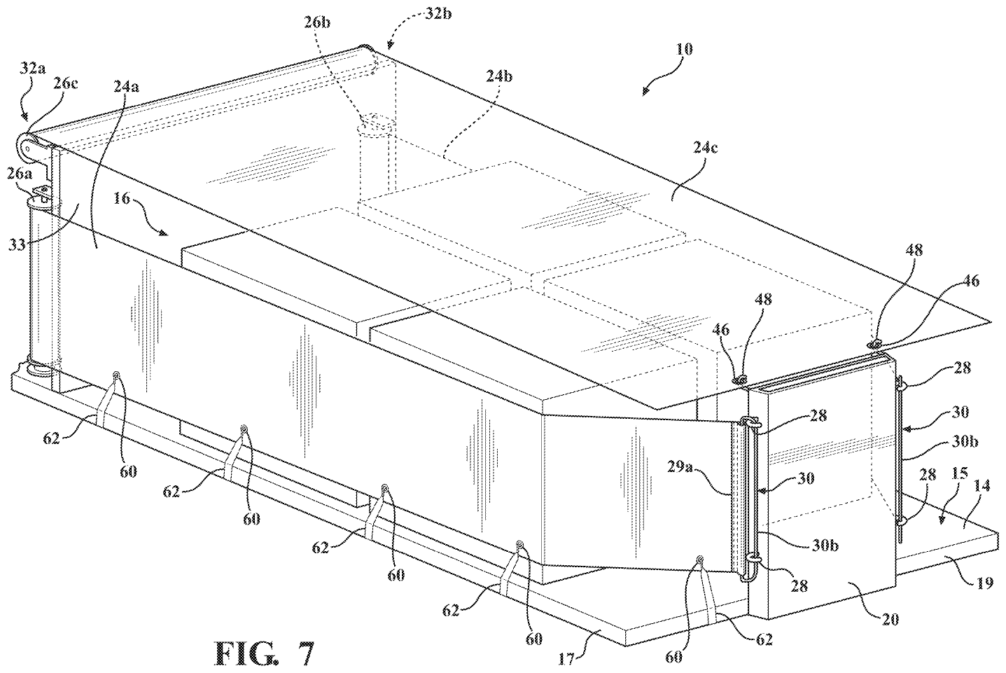

In use, the tarping system 10 is easy to deploy from the stowed position to the deployed position, and then to return from the deployed position back to the stowed position, and thus, the operator will not be hesitant to use the tarping system 10 when needed, such as when driving into a sudden onset of rain or the like, unlike that when an operator only possesses a cumbersome, heavy, hard to deploy known tarp, such as discussed in the background above. In accordance with one aspect, the tarping system 10 may be used as follows. Once the cargo load 16 (e.g., stacks of drywall) is placed on the cargo carrying surface 15 of the truck/trailer bed 14, a single operator, while standing on the ground surface GS alongside the truck/trailer 12, can easily and intuitively cover the sides of the cargo load 16 by simply grasping the handle 30 and walking the respective tarp 24a, 24b along the lengthwise direction of the truck/trailer 12 toward the rear of the bed 14, causing the tarp 24a, 24b to unroll from the reel 26 against the bias force of the spring or other mechanism which is constantly biasing the associated reel 26a, 26b toward the stowed/rolled position of the tarp 24a, 24b. Accordingly, the tarp 24a, 24b is desirably kept taught by the imparted bias. When the operator reached the back of the truck 12, the operator positions the handle 30 in the C-channel catch member or about the hooks 28 which facilitate supporting and holding the tarp 24a, 24b in the fully deployed condition to cover the side of the cargo load 16 along its full length and about 4 feet up from the cargo carrying surface 15 of the bed 14 (or the selected width of the tarp 24). The lower edge of the tarp 24a, 24b can be provided with a plurality of grommets 60 which serve as reinforced openings spaced along the length of the tarp 24a, 24b. Bungee cords or other suitable tie down devices 62 (FIG. 7) may be used to engage the grommets 60 at one end thereof and hook to the edge of the bed 14 at the other end so as to secure the lower edge of the tarp 24a, 24b against the bed 14 in use, thereby facilitating maintaining the tarp 24a, 24b in widthwise taught relation to the bed 14, thereby helping to reduce the onset of fluttering of the tarp 24a, 24b at highway speeds and the reduction of noise producing therefrom. The same steps above can then carried out on the opposite side of the truck 12 to quickly and easily tarp the other side of the cargo load 16. The top of the cargo load 16 above the tarps 24a, 24b, if desired, can remain uncovered, also referred to as untarped.

As mentioned above, the reels 26a, 26b and catch members 28 may be inset from the cargo load 16, such that the tarp 24a, 24b, when deployed, can bow outwardly around the cargo load 16, accommodating cargo loads of various sizes and shapes, as well as full and partial loads — all while keeping the tarps 26a, 26b taught when deployed. This helps keep wind from getting behind the tarps 24a, 24b in use, thereby reducing drag and fluttering of the tarps 24a, 24b, thus, reducing noise, wear, and improving fuel economy.

Of course, although the top of the cargo load 16 can remain untarped, such as may be desired during nice weather, the third tarp 24c can be pulled from the third reel 26c and releasably fixed in covering relation over the top of the cargo load 16 to protect the upper surface of the cargo load 16 against exposure to contamination (water and solid debris), particularly during or in anticipation of foul, inclement weather. The third tarp 24c can be easily deployed to its extended use position, as shown in FIG. 10, such as via use of a standard fork lift 63 or the like, if desired, wherein a hook member 64 can be operably affixed to forks 66 of the fork lift 63 to quickly pull the third tarp 24c outwardly in the lengthwise direction from the third reel 26c, whereupon the grommets 46 can be releasably attached to the corresponding hook members 48 on the crane pedestal 20. A simple reversal of the deployment steps can be used, if desired, to return the third tarp 24c to its self-coiled, stowed position in the third reel 26c.

Once the selected tarp(s) 24a, 24b, 24c are deployed to their in-use position, the operator may further secure the cargo load 16 in the normal course by extending anchoring straps (not shown) over the cargo load 16 to secure the cargo load 16 to the bed 14 in the usual manner. The anchoring straps can be deployed beneath the overhead tarp 24c, while extending over the upright tarp(s) 24a, 24b, and thus, can further assist in holding the vertically extending, upright tarps 24a, 24b in place during use, if desired.

Once tarped and strapped, as desired, the truck 12 may freely travel along wet roads without concern for the cargo load 16, as any water spray coming off the tires and truck 12, or passing vehicles, that would otherwise land on the lower portion of the sides of the cargo load 16 (lower 2-4 feet, by way of example and without limitation) and cause potential damage to the cargo load 16 is blocked by the vertical, upstanding tarps 24a, 24b, keeping the sides of the cargo load 16 dry. Of course, if the third tarp 24c is deployed, it also protects the upper surface of the cargo load 16 from exposure to water spray and falling rain, thus, further keeping the cargo load 16 dry. Once at the delivery location, the operator can unstrap the cargo load 16, and then untarps the cargo load 16 by simply removing any bungee cords used and then simply releasing the handles 30 from the catch members 28 and walking the first and second side tarps 24a, 24b toward their reels 26 under the self-coiling assistance of the constant spring bias imparted by the aforementioned spring members of the associated first and second reels 26a, 26b, which causes the tarps 24 to automatically self-roll onto their reels 26a, 26b until fully stowed about the spool portion of the reels 26a, 26b. The above deployment steps of the tarps 24a, 24b, 24c and return to stowed position of the tarps 24a, 24b, 24c all happens under the control of a single operator and without the operator ever having to leave the ground surface GS or otherwise climb onto the bed 14 or onto the cargo load 16.

In accordance with a further aspect, a method 1000 of tarping a cargo load 16 carried on a cargo carrying surface 15 of a bed 14 of a truck or trailer 12 includes: a step 1100 of providing at least one reel 26a, 26b mounted in an upstanding relation relative to the cargo carrying surface 15 with each of the reels 26a, 26b being operative to self-coil a tarp 24a, 24b under a mechanical bias force onto a spool portion of the reel 26a, 26b to a stowed position. Further, a user, while standing on a ground surface GS, proceeding in a step 1200 by drawing the tarp 24a, 24b off one or more of the spool portions of the at least one reel 26a, 26b against the mechanical bias force to an extended, deployed position to cover at least a portion of a side of the cargo load 16 and releasably fixing the tarp 24a, 24b in the extended, deployed position.

According to another aspect, the method 1000 can further include a step 1300 of providing the at least one reel including two reels 26a, 26b supported in the upstanding relation on opposite sides of the cargo carrying surface 15, and wherein the user covers at least a portion of the opposite sides of the cargo load 16 by individually drawing the upstanding tarps 24a, 24b off the reels 26a, 26b against the mechanical bias force and securing grab handles 30 coupled to the tarps 24a, 24b with respective catch members 28 fixed relative to the truck bed or trailer 14.

According to another aspect, the method 1000 can further include a step 1400 of providing the at least one reel including an overhead top reel 26c with a top tarp 24c self-coiled thereon under a mechanical bias force, wherein the user extends the top tarp 24c against the mechanical bias force to cover at least a portion of a top surface of the cargo load 16.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A tarping system for covering at least a portion of a cargo load carried on a cargo carrying surface of a bed of a truck or trailer, the tarping system comprising:
at least one flexible tarp extending along a lengthwise direction from a mounted end to a free end;
at least one reel coupled to the mounted end of the tarp and operative to urge the tarp toward a stowed positon, coiled onto a spool of the reel, under a return force imparted by the reel, while enabling a user to draw the tarp outwardly from the reel in the lengthwise direction against the return force from the stowed position to a deployed position; and
at least one mounting structure configured to support the at least one reel and the at least one tarp in an upstanding relation relative to the cargo carrying surface to enable the user to draw the tarp from the stowed position to the deployed position to cover at least a portion of a side of the cargo load.

2. The tarping system of claim 1, wherein the at least one flexible tarp includes first and second flexible tarps, the at least one reel includes first and second reels, and the at least one mounting structure includes first and second mounting structures, each of the first and second mounting structures being configured to support separate ones of the first and second reels and separate ones of the first and second tarps in the upstanding relation on opposite sides of the cargo carrying surface to cover at least a portion of opposite sides of the cargo load.

3. The tarping system of claim 2, wherein the first and second flexible tarps each have a length extending from the mounted end to the free end and a width extending generally transversely to the length, wherein the length is greater than the width.

4. The tarping system of claim 2, wherein the at least one flexible tarp includes a third flexible tarp, the at least one reel includes a third reel, and the at least one mounting structure includes a third mounting structure, the third mounting structure being configured to support the third reel and the third flexible tarp in generally transverse relation to the first and second reels and the first and second tarps for covering at least a portion of a top of the cargo load.

5. The tarping system of claim 2, wherein the first and second flexible tarps each include a grab handle coupled to the free end, the grab handles being configured to be grasped by the user, while standing on a ground surface, for tensioning the first and second tarps while drawing the first and second tarps from the stowed position to the deployed position against the return force and while returning the tarps from the deployed position to the stowed position under the return force.

6. The tarping system of claim 5, further including catch members operably fixed to the cargo carrying surface in spaced relation along the lengthwise direction from the first and second reels for releasably engaging the grab handles to releasably hold the first and second tarps in the deployed position.

7. The tarping system of claim 2, wherein each of the first and second mounting structures include a first and second top bracket operably fixed relative to the cargo carrying surface for slideably receiving a top end of the first and second reels and a first and second bottom bracket operably fixed relative to the cargo carrying surface for supporting a bottom end of the first and second reels, said first and second mounting structures being configured to orient the first and second reels facing forward toward a front of the truck or trailer.

8. The tarping system of claim 7, wherein each of the first and second top brackets is dimensioned to enable the top end of the first and second reels to be extended sufficiently into a top receptacle of the respective first and second top brackets, whereupon the first and second reels can be lowered to slide and seat the bottom ends into a bottom receptacle of the respective first and second bottom brackets for purposes of mounting the first and second reels, and to enable the reverse to occur to dismount the first and second reels from the first and second mounting structures.

9. The tarping system of claim 1, wherein the mounted end of the at least one tarp includes at least one of openings for releasably coupling the at least one tarp to the at least one reel, or a portion of a hook and loop fastener for releasably coupling the tarp to the at least one reel.

10. The tarping system of claim 1, wherein the return force imparted by the reel is a constant spring biased return force.

11. A method of tarping a cargo load carried on a cargo carrying surface of a bed of a truck or trailer, comprising:
providing at least one reel mounted in an upstanding relation relative to the cargo carrying surface, each of said at least one reel being operative to self-coil a tarp under a bias force onto a spool of the reel to a stowed position; and
a user, while standing on a ground surface, drawing the tarp off the spool of the at least one reel against the bias force to an extended position to cover at least a portion of a side of the cargo load and releasably fixing the tarp in the extended position.

12. The method of claim 12, including providing the bias force as a spring bias.

13. The method of claim 11, including providing a grab handle at a free end of the tarp for grasping by the user while standing on the ground surface.

14. The method of claim 13, including providing at least one catch member in spaced relation from the at least one reel with the at least one catch member being operative to enable the user, while standing on the ground surface, to releasably engage the grab handle with the at least one catch member to releasably hold the tarp in the extended position.

15. The method of claim 14, further including the user, while standing on the ground surface, releasing the tarp from the extended position by grasping the grab handle and releasing it from the at least one catch member and then allowing the tarp to be self-coiled onto the reel to the stowed position under the bias force.

16. The method of claim 15, further including providing the at least one reel including two reels supported in the upstanding relation on opposite sides of the cargo carrying surface, and wherein the user covers at least a portion of the opposite sides of the cargo load by individually drawing the tarps off the reels against the bias force and securing the grab handles with respective catch members.

17. The method of claim 16, including providing the at least one reel including an overhead top reel with a top tarp self-coiled thereon under a bias force, wherein the user extends the top tarp against the bias force to cover at least a portion of a top surface of the cargo load.

18. The method of claim 16, wherein the user supports the two upstanding tarps in their extended positons by coupling the grab handles with interconnecting structure.

19. The method of claim 16, wherein the tarps and reels are mounted toward a front of the cargo carrying surface facing a front of the truck or trailer and the catch members are provided toward a rear of the cargo carrying surface.

20. The method of claim 16, wherein the reels and tarps are mounted by a mounting structure including a bottom bracket that engages a bottom end of the reels and a top bracket that engages a top end of the reels.
